(19) United States
(12) Patent Application Publication
(10) Pub. No.: US 2008/0191624 A1
(43) Pub. Date: Aug. 14, 2008

(54) PLASMA DISPLAY DEVICE

(76) Inventors: Chong-Gi Hong, Suwon-si (KR); Tae-Kyoung Kang, Suwon-si (KR); Seong-Hun Choo, Suwon-si (KR); Yong-Jun Kim, Suwon-si (KR); Yong-Su Park, Suwon-si (KR); Joo-Ri Kwak, Suwon-si (KR); Ki-Jong Eom, Suwon-si (KR); Min-Sic Kim, Suwon-si (KR)

Correspondence Address: CHRISTIE, PARKER & HALE, LLP, PO BOX 7068, PASADENA, CA, 91109-7068, US

(21) Appl. No.: 12/027,201

(22) Filed: Feb. 6, 2008

(30) Foreign Application Priority Data
Feb. 8, 2007 (KR) 10-2007-0013309

(51) Int. Cl. H01J 17/49

(52) U.S. Cl. 313/582

(57) ABSTRACT

A plasma display device including: a plasma display panel adapted to create images and including a front substrate, a rear substrate, a plurality of discharge cells defined between the front substrate and the rear substrate, and phosphors coated in the discharge cells; and a filter attached to a front surface of the front substrate and adapted to serve as an image display surface, wherein the filter and the phosphors are respectively colored with first and second colors that are different from each other.

### CROSS-REFERENCE TO RELATED PATENT APPLICATION

This application claims priority to and the benefit of Korean Patent Application No. 10-2007-0013309, filed on Feb. 08, 2007, in the Korean Intellectual Property Office, the entire content of which is incorporated herein by reference.

### BACKGROUND OF THE INVENTION

1. Field of the Invention

The present invention relates to a plasma display device, and more particularly, to a plasma display device having an improved bright room contrast.

2. Description of the Related Art

A plasma display device is a flat panel display that displays images using a gas discharge phenomenon. Plasma display devices have been highlighted as next generation flat panel displays that can replace Cathode Ray Tubes (CRTs) since they have excellent display capabilities in terms of display capacity, brightness, contrast, afterimage, and viewing angle, and furthermore, are thin and can achieve a large-size display.

Generally, a plasma display device includes a plasma display panel creating images and a front filter disposed in front of the plasma display panel to improve image quality and to shield electromagnetic waves.

In the plasma display panel, when discharge occurs in a plurality of discharge cells defined between two substrates, ultraviolet rays are generated and converted to visible light that can be sensed by a viewer, thereby achieving images through the emission of the visible light.

When external visible light incident on a transparent front substrate is reflected from a white transparent dielectric layer, white barrier ribs, apparently white phosphors, etc., and then passes through from the front substrate, reflection brightness is increased, thereby reducing the bright room contrast of the plasma display panel.

In view of the above-described problem, according to a conventional method, black stripes are formed using a dark material with low reflectivity in order to absorb external incident light, thereby reducing reflection brightness. However, in order to separately form the black stripes, additional paste coating and patterning processes are needed. In addition, since the black stripes are only formed in some areas in order to prevent the black stripes from blocking the emission of visible light, absorption of external light is only performed over a very limited area of a plasma display panel.

A glass filter is mainly used as a front filter in front of a plasma display panel. However, the glass filter is heavy and must be carefully handled due to the characteristics of a glass material, which requires the formation of a separate supporting structure for firmly installing the glass filter.

### SUMMARY OF THE INVENTION

An aspect of the present invention is directed toward a plasma display device improving a bright room contrast based on a subtractive color mixing principle and a complementary color effect.

Another aspect of the present invention is directed toward a plasma display device with an improved filter structure, thereby reducing manufacturing costs and providing improved images.

An embodiment of the present invention provides a plasma display device including: a plasma display panel adapted to create images and including a front substrate, a rear substrate, a plurality of discharge cells defined between the front substrate and the rear substrate, and phosphors coated in the discharge cells; and a filter attached to a front surface of the front substrate and adapted to serve as an image display surface, wherein the filter and the phosphors are respectively colored with first and second colors that are different from each other.

Another embodiment of the present invention provides a plasma display device including: a plasma display panel for creating images and including a front substrate, a rear substrate, a plurality of discharge cells defined between the front substrate and the rear substrate, and phosphors coated in the discharge cells; and a filter attached to a front surface of the front substrate and adapted to serve as an image display surface, wherein complementary first and second colors alternate from front to back so that the filter is colored with the first color, the front substrate is colored with the second color, and the phosphors are colored with the first color.

Another embodiment of the present invention provides a plasma display device including: a plasma display panel including a front substrate supporting a plurality of discharge electrodes, a front dielectric layer covering the discharge electrodes, barrier ribs defining a plurality of discharge cells between the front substrate and the rear substrate, phosphors coated in the discharge cells, and a discharge gas filled in the discharge cells; and a filter attached to a front surface of the front substrate and adapted to serve as an image display surface, wherein complementary first and second colors alternate from front to back so that the filter is colored with the first color, the front substrate is colored with the second color, the front dielectric layer is colored with the first color, and the phosphors are colored with the second color.

Another embodiment of the present invention provides a plasma display device including: a plasma display panel adapted to create images and including a front substrate, a rear substrate, a plurality of discharge cells disposed between the front substrate and the rear substrate, and phosphors coated in the discharge cells; and a front filter at a front of the front substrate and adapted to serve as an image display surface, including a transparent substrate and a plurality of external light-absorbing patterns arranged at intervals on the transparent substrate, wherein the external light-absorbing patterns and the phosphors are respectively colored with complementary first and second colors.

Another embodiment of the present invention provides a plasma display device including: a plasma display panel adapted to create images and including a front substrate, a rear substrate, a plurality of discharge cells disposed between the front substrate and the rear substrate, and phosphors coated in the discharge cells; and a front filter, at a front of the front substrate and adapted to serve as an image display surface, including a transparent substrate and a plurality of external light-absorbing patterns arranged at intervals on the transparent substrate, wherein complementary first and second colors alternate from front to back so that the external light-absorbing patterns are colored with the first color, the front substrate is colored with the second color, and the phosphors are colored with the first color.

### BRIEF DESCRIPTION OF THE DRAWINGS

The accompanying drawings, together with the specification, illustrate exemplary embodiments of the present invention, and together with the description, serve to explain the principles of the present invention.

FIG. 1 is an exploded perspective view illustrating a plasma display device according to a first embodiment of the present invention;

FIG. 2 is a cross-sectional view taken along lines II-II and II′-II′ of FIG. 1;

FIG. 3 is a color circle diagram illustrating subtractive color mixing of different colors and complementary color relationships;

FIG. 4 is a cross-sectional view illustrating a plasma display device according to a second embodiment of the present invention;

FIG. 5 is a cross-sectional view illustrating a plasma display device according to a third embodiment of the present invention;

FIG. 6 is a cross-sectional view illustrating a plasma display device according to a fourth embodiment of the present invention;

FIG. 7 is a cross-sectional view illustrating a plasma display device according to a fifth embodiment of the present invention;

FIG. 8 is a cross-sectional view illustrating a plasma display device according to a sixth embodiment of the present invention;

FIG. 9 is a cross-sectional view illustrating a plasma display device according to a seventh embodiment of the present invention;

FIG. 10 is a cross-sectional view illustrating a plasma display device according to an eighth embodiment of the present invention;

FIG. 11 is a cross-sectional view illustrating a plasma display device according to a modified embodiment of FIG. 10;

FIG. 12 is an exploded perspective view illustrating a plasma display device according to a ninth embodiment of the present invention;

FIG. 13 is a cross-sectional view taken along a line XIII-XIII of FIG. 12;

FIG. 14 is a cross-sectional view illustrating a plasma display device according to a tenth embodiment of the present invention; and

FIG. 15 is a cross-sectional view illustrating a plasma display device according to a modified embodiment of the embodiment of FIG. 14.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

### First Embodiment

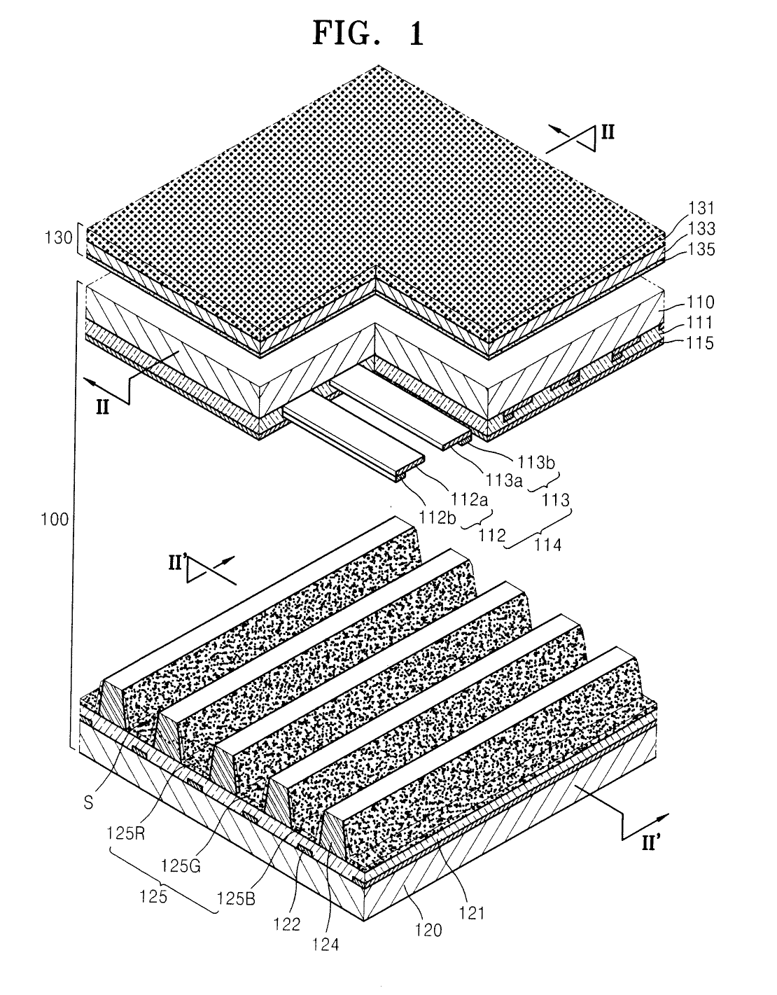

FIG. 1 is an exploded perspective view illustrating a plasma display device according to a first embodiment of the present invention, and FIG. 2 is a vertical sectional view taken along lines II-II and II′-II′ of FIG. 1. Referring to FIGS. 1 and 2, the plasma display device of the first embodiment of the present invention includes a plasma display panel 100 creating images and an attachable filter 130 directly attached to an image display surface of the plasma display panel 100.

The plasma display panel 100 includes a front substrate 110 and a rear substrate 120 that are disposed to face each other and are separated from each other by a distance (e.g. a predetermined distance), and barrier ribs 124 defining a plurality of discharge cells S between the front substrate 110 and the rear substrate 120. The front substrate 110 and the rear substrate 120 may be glass substrates made of a glass material. The barrier ribs 124 disposed between the front substrate 110 and the rear substrate 120 may be arranged in open-type stripe patterns as illustrated in FIGS. 1 and 2, or in closed-type matrix patterns. A plurality of discharge electrode pairs 114 inducing a display discharge are arranged parallel to each other on a surface of the front substrate 110. Each pair of discharge electrodes 112 and 113 include transparent electrodes 112a and 113a made of a transparent conductive material such as indium tin oxide (ITO); and bus electrodes 112b and 113b, disposed to face the transparent electrodes 112a and 113a, one end of the bus electrodes 112b and 113b being connected to an external power source to supply power to the transparent electrodes 112a and 113a. However, the technical scope of the present invention is not limited by the above discharge electrode structure. A dielectric layer 111 covers (or buries) the discharge electrode pairs 114, and a protective layer 115 covering the dielectric layer 111 may be sequentially disposed on the front substrate 110.

A plurality of address electrodes 122 inducing an address discharge may be disposed on the rear substrate 120. The address electrodes 122 may covered by (or buried in) a dielectric layer 121. The discharge cells S are filled with a discharge gas that is excited by a display discharge to generate ultraviolet rays. The dielectric layer 121 and the barrier ribs 124 defining the discharge cells S are coated with phosphors 125 converting ultraviolet rays generated by discharge to visible light.

The attachable filter 130 is disposed on a front surface of the front substrate 110 serving as an image display surface. The attachable filter 130 is directly attached to the front substrate 110. The attachable filter 130 includes a base film 131, an electromagnetic wave-shielding layer 133 attached to a surface of the base film 131, and an adhesive layer 135, interposed between the attachable filter 130 and a plasma display panel 100 and facilitating a binding between the attachable filter 130 and the plasma display panel 100. The base film 131 serves as a support structure of the attachable filter 130, and may be made of polyethersulphone (PES), polyacrylate (PAR), polyetherimide (PEI), polyethylenenaphthalate (PEN), polyethyleneterephthalate (PET), polyphenylene sulfide (PPS), polyallylate, polyimide, polycarbonate (PC), cellulose triacetate (TAC), cellulose acetate propinonate (CAP), or the like. In one embodiment, polycarbonate, polyethyleneterephthalate, cellulose triacetate, and polyethylenenaphthalate are preferred.

The base film 131 may be colored with a first color to reduce the reflection of external light and to increase contrast. For this, the base film 131 may include a coloring material, e.g., a blue-coloring material such as Mn, Ni, or Co, or an orange-coloring material such as Cu, Sb, or Cr. The attachable filter 130 wholly exhibits a first color due to the colored base film 131. Provided that the attachable filter 130 exhibits the first color, some layers constituting the attachable filter 130 may be colored with the first color, or alternatively all layers constituting the attachable filter 130 may be colored with the first color.

The electromagnetic wave-shielding layer 133 serves to prevent electromagnetic interference between the plasma display panel 100 and the ambient environment, thereby preventing malfunction of external electronic equipment and assuring normal operation of the plasma display panel 100. The electromagnetic wave-shielding layer 133 may be formed in a mesh structure made of a metal material with good conductivity. In addition, the electromagnetic wave-shielding layer 133 may be formed as a single metal layer or a single metal oxide layer such as an ITO layer. The electromagnetic wave-shielding layer 133 may also be formed as two or more metal layers, two or more metal oxide layers, or a composite layer of at least one metal layer and at least one metal oxide layer.

The attachable filter 130 is a multi-layered structure including the base film 131 and the electromagnetic wave-shielding layer 133, which are separately prepared and are stacked one upon the other. In order to manufacture the attachable filter 130, the base film 131 and the electromagnetic wave-shielding layer 133 are separately formed, and thus, a film formation process must be performed twice or more. For the sake of process convenience, a single-layered attachable filter having both a base film function and an electromagnetic wave-shielding function may be utilized. For example, such an attachable filter may be formed to have a composite material structure wherein an electromagnetic wave-shielding conductive mesh is contained in a base film resin. In this case, the attachable filter can be formed by performing one film formation process.

The phosphors 125 are distributed in areas defined by the barrier ribs 124. The phosphors 125 are colored with a second color. The second color of the phosphors 125, together with the first color of the attachable filter 130, produces a dark color through subtractive color mixing. This can be explained by the characteristic of subtractive color mixing that as different colors of paints are mixed, brightness and saturation of the resulting color are lowered, thereby producing a dark color. In particular, when a first color and a second color form a complementary color relationship, an image display surface of a display device appears black or near-black through mixing of the first color and the second color. Thus, a combination of complementary first and second colors enables external light incident onto a display device to be absorbed. Effectiveness of such a complementary color effect can be reliably demonstrated by comparing a conventional plasma display device with a plasma display device according to the first embodiment of the present invention in terms of external light reflection brightness. The external light reflection brightness of a plasma display device according to the first embodiment of the present invention may be about 10.2 cd/m² due to a complementary color principle which is reduced as compared with the external light reflection brightness (about 15.2 cd/m²) of a conventional plasma display device. The external light reflection brightness affects a bright room contrast ratio, which is an indicator of image quality, and the bright room contrast ratio can be defined as follows:

$$Bright room contrast ratio = \frac{peak brightness + background brightness}{external light reflection brightness + background brightness}$$

where the peak brightness is brightness of the highest light output level that can be achieved in a panel, i.e., brightness achieved when the gray level of 256 is displayed on all pixels, and the background brightness is brightness of the lowest light output level that can be achieved in a panel, i.e., brightness achieved when the gray level is 0. As measured under the same conditions, the bright room contrast ratio of a plasma display device according to the first embodiment of the present invention is about 93:1 which is improved as compared with the bright room contrast ratio (about 70:1) of a conventional plasma display device.

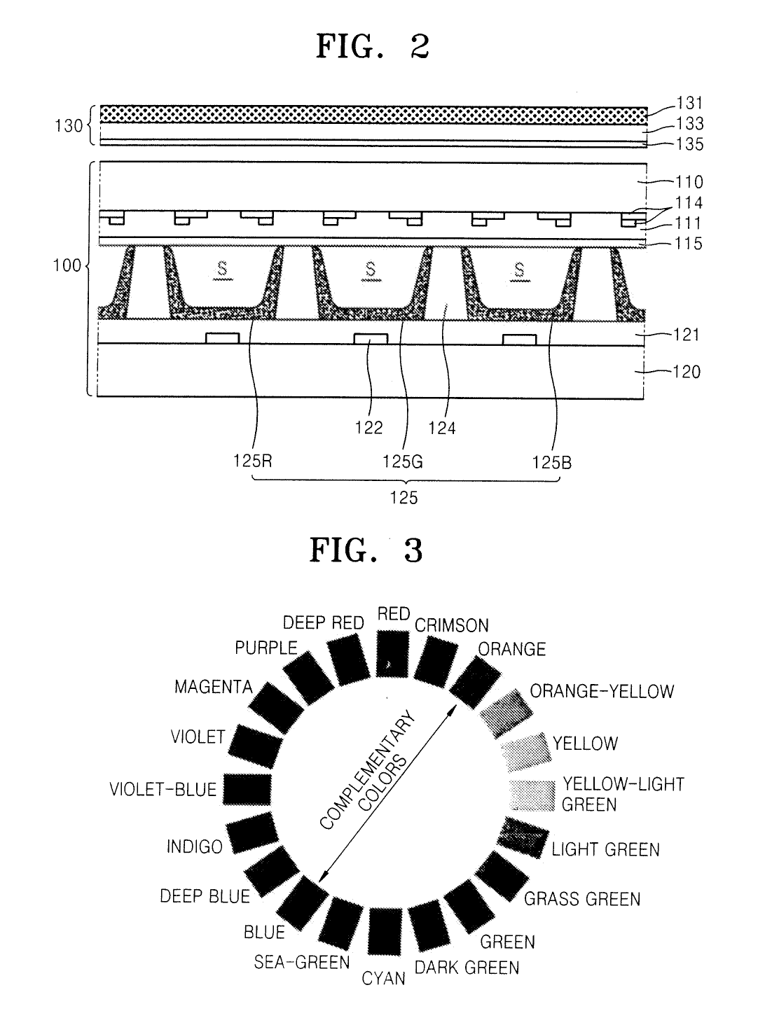

There are many complementary color pairs. In order to impart a color tone (e.g. a predetermined color tone) according to process convenience or individual preference, complementary color pairs (e.g. predetermined complementary color pairs) can be selected. FIG. 3 illustrates a color circle for explaining subtractive color mixing. Referring to the color circle of FIG. 3, mixing colors at neighboring positions produces an intermediate color, and mixing colors which are located far from each other produces a near-gray color due to a lowering of brightness and saturation. Mixing complementary colors which are located at opposite positions (or directly across the circle from each other) produces a black color or a near-black color. As illustrated in FIG. 3, there are many complementary color pairs, e.g., red-cyan, yellow-indigo, and blue-orange. However, when selecting a complementary color pair, the attachable filter 130 directly exposed to external light may be colored with a color having a low brightness, and the absorption of external light can be directly facilitated by the attachable filter 130, which is more advantageous in terms of contrast. When the first color of the attachable filter 130 and the second color of the phosphors 125 are mutually exclusively selected from complementary blue and orange colors, coloring the attachable filter 130 with a blue color having a relatively low brightness may be more advantageous in terms of contrast.

The phosphors 125 may include a coloring material, e.g., a blue-coloring material such as Mn, Ni, or Co, or an orange-coloring material such as Cu, Sb, or Cr. Of course, various other coloring materials can also be used provided that manufacturing is feasible.

Generally, full-color images are created through combination of different monochromatic lights. The monochromatic lights differentially contribute to a total brightness according to their wavelength ranges. Generally, color images are created mainly through combinations of the three primary colors of light, i.e., red, green, and blue. It is known that about 50% of the total brightness is achieved by green light, and thus, green light has the most significant effect on the total brightness. Thus, when emission efficiency is reduced by the addition of a coloring material to a green phosphor, a reduction in brightness over the entire display may occur. In this regard, coloration may be selectively performed according to the type of phosphors, instead of coloring all phosphors. For example, in order to maintain brightness, green phosphors may not be colored, whereas red and/or blue phosphors may be colored. In another example, taking into consideration that phosphors have different emission efficiencies, no coloring material may be added to blue phosphors with the lowest emission efficiency, whereas red and/or green phosphors may be colored, thereby achieving an entire balance in color tone.

### Second Embodiment

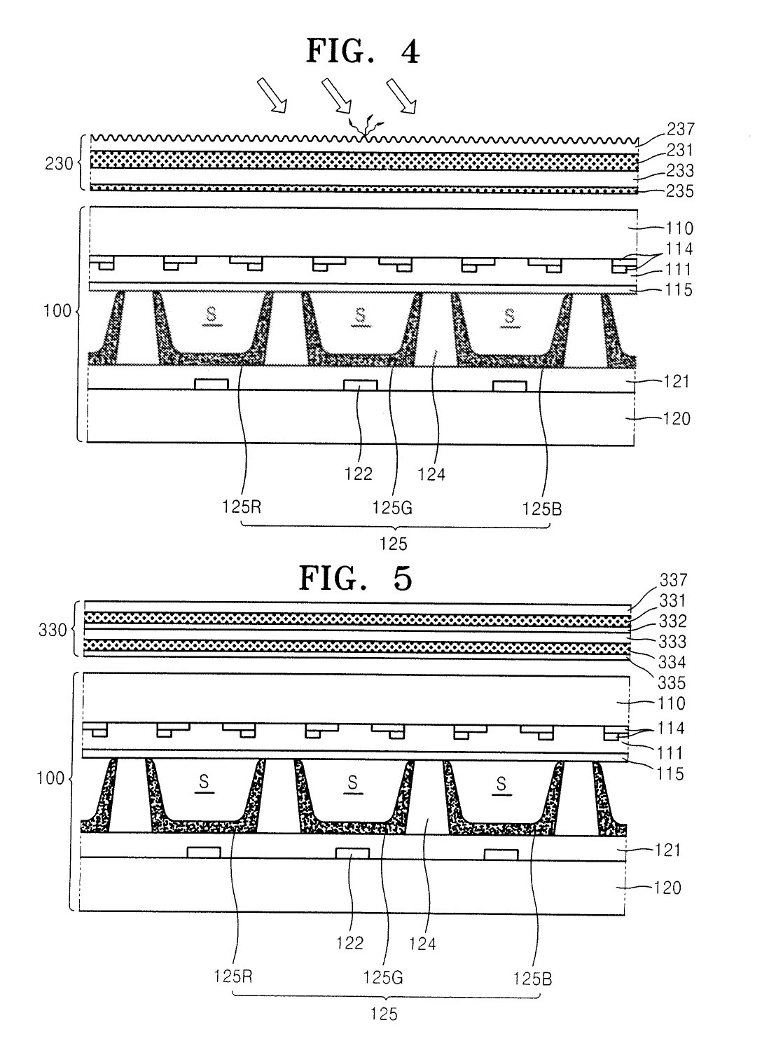

FIG. 4 is a cross-sectional view illustrating a plasma display device according to a second embodiment of the present invention. Referring to FIG. 4, an attachable filter 230, according to the second embodiment of the present invention, includes a base film 231, an anti-glare layer 237 disposed on a surface of the base film 231, an electromagnetic wave-shielding layer 233 disposed on the other surface of the base film 231, and an adhesive layer 235, interposed between the attachable filter 230 and a plasma display panel 100, facilitating a binding between the attachable filter 230 and the plasma display panel 100.

The anti-glare layer 237 may have a fine concavo-convex surface pattern as illustrated in FIG. 4, or may have a regular or irregular surface pattern of a plurality of fine (or small) dots. The anti-glare layer 237 scatters or diffuses external light incident on the plasma display panel 100 over a wide angle so that external light is not sensed by a viewer or the amount of external light sensed by a viewer can be significantly reduced.

The adhesive layer 235 serves to fix the attachable filter 230 to a front surface of the plasma display panel 100, and may be made of a thermosetting resin or a UV curable resin that can be cured in response to a temperature condition or light. For example, an acrylate-based resin, a pressure sensitive adhesive (PSA), or the like may be used.

When needed, an additional function, e.g., near-infrared-shielding, color correction, or neon light-shielding, may be added to the adhesive layer 235. To this end, for example, the adhesive layer 235 may include a near-infrared-shielding/absorbing material such as a copper compound or a phosphor compound. In an embodiment of the present invention, the attachable filter 230 exhibits a first color. For this, the adhesive layer 235 may be colored with the first color. When the adhesive layer 235, together with the base film 231, is colored with the first color, a coloration effect can be reinforced. The color correction of the adhesive layer 235 can also be achieved by coloring the adhesive layer. As such, both the base film 231 and the adhesive layer 235 may be colored with the first color or one of the base film 231 and the adhesive layer 235 may be selectively colored. In addition, provided that manufacturing is feasible, other layers of the attachable filter 230 may also be colored.

Like in the previous embodiment, in the second embodiment of present invention, subtractive color mixing occurs in overlapping regions of the attachable filter 230 colored with the first color and phosphors 125 colored with a second color, thereby producing a dark color, which is advantageous in terms of absorption of external light. In particular, when the first color and the second color form a complementary color relationship, an overlapping region of the first color and the second color appears black or near-black, thereby further facilitating the absorption of external light. Although not shown, as a modified embodiment of the attachable filter 230 illustrated in FIG. 4, an anti-reflective layer may be substituted for the anti-glare layer 237 constituting a front surface of the attachable filter 230. The anti-reflective layer prevents external incident light from being reflected from an attachable filter, and may be formed by stacking a plurality of material layers with different refractive indices. Although the anti-reflective layer is based on a different principle from the anti-glare layer 237, both layers have the same purpose in that they prevent or reduce the amount of external light being sensed, thereby improving the contrast of an image.

### Third Embodiment

FIG. 5 is a cross-sectional view illustrating a plasma display device according to a third embodiment of the present invention. Referring to FIG. 5, an attachable filter 330, according to the third embodiment of the present invention, includes a first base film 331 and a second base film 334 that are spaced apart from each other. The first base film 331 supports an anti-reflective layer 337 on a surface thereof and an adhesive layer 332 on the other surface thereof, and the second base film 334 supports an electromagnetic wave-shielding layer 333 on a surface thereof and an adhesive layer 335 on the other surface thereof. The first base film 331, the second base film 334, and the constitutional elements supported by the first base film 331 and the second base film 334 are adhered via the adhesive layer 332. The attachable filter 330 is directly attached to a plasma display panel 100 via the adhesive layer 335.

The first and second base films 331 and 334 may be colored with a first color. Alternatively, only one of the first and second base films 331 and 334 may also be selectively colored with the first color, provided that the attachable filter 330 exhibits the first color. When at least one of the adhesive layers 332 and 335 is colored with the same color as the first base film 331 and/or the second base film 334, the coloration effect of the attachable filter 330 can be further reinforced.

Phosphors 125 coated in areas defined by barrier ribs 124 may be colored with a second color complementary to the first color. The second color of the phosphors 125 is mixed with the first color of the attachable filter 330 via a transparent dielectric layer 111 and a front substrate 110, thereby producing a black-based color which is advantageous in terms of absorption of external light. An anti-glare layer may be substituted for the anti-reflective layer 337 constituting a front surface of the attachable filter 330.

### Fourth Embodiment

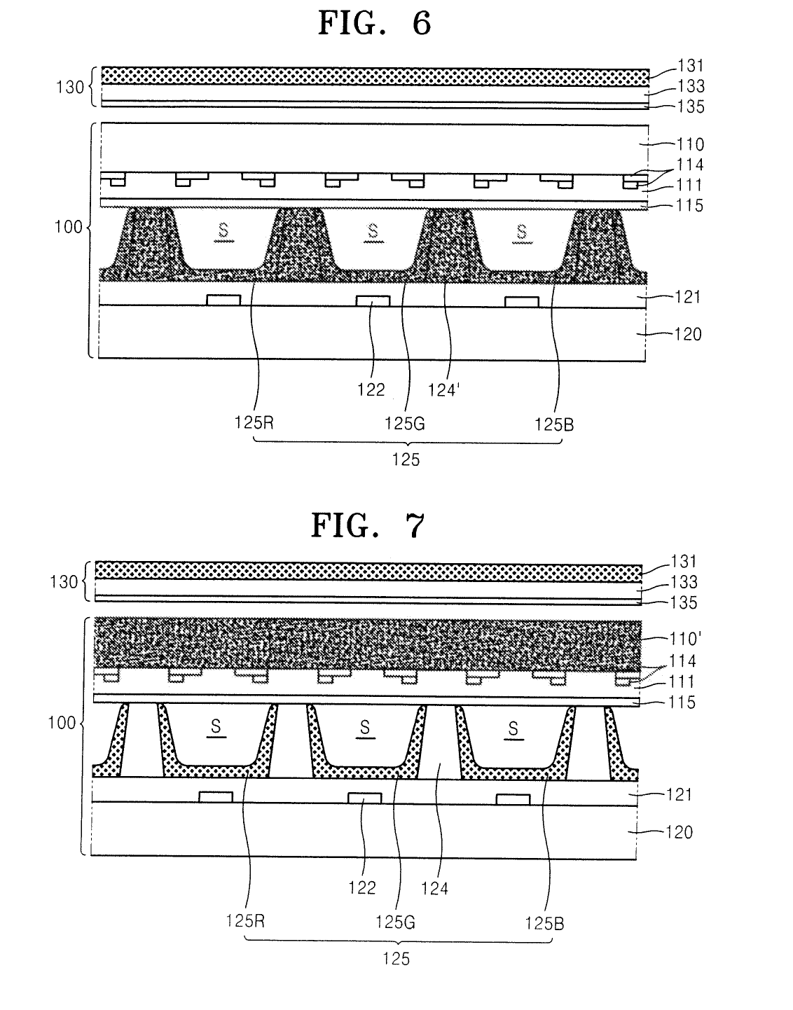

FIG. 6 is a cross-sectional view illustrating a plasma display device according to a fourth embodiment of the present invention. Referring to FIG. 6, the plasma display device according to the fourth embodiment of the present invention includes a plasma display panel 100 creating images and an attachable filter 130 disposed at an image display surface of the plasma display panel 100. The attachable filter 130 can be variously structured provided that it exhibits a first color, as described in the previous embodiments.

The fourth embodiment of the present invention is different from the previous embodiments in that barrier ribs 124′, together with phosphors 125, are colored with a second color. Taking into consideration that complementary first and second colors provide a complementary color effect in overlapping regions, when the attachable filter 130 is colored with the first color, and the barrier ribs 124′, which are non-display areas, as well as the phosphors 125 are colored with the second color complementary to the first color, the absorption of external light based on a complementary color effect can be substantially achieved over an entire display surface. The barrier ribs 124′ may be formed by coating a barrier rib paste containing a coloring material on regions (e.g. predetermined regions). For example, an orange-coloring material such as Cu, Sb, or Cr or a blue-coloring material such as Mn, Ni, or Co may be added to a barrier rib paste to form blue- or orange-colored barrier ribs. Meanwhile, the barrier ribs 124′ must exhibit a color (e.g. a predetermined color) when viewed from a front substrate 110 displaying images. Although the barrier ribs 124′ may be wholly colored, only top parts of the barrier ribs 124′ close to the front substrate 110 may be selectively colored.

### Fifth Embodiment

FIG. 7 is a cross-sectional view illustrating a plasma display device according to a fifth embodiment of the present invention. Referring to FIG. 7, the plasma display device according to the fifth embodiment of the present invention includes a plasma display panel 100 creating images and an attachable filter 130 attached to an image display surface of the plasma display panel 100. The fundamental structure of the attachable filter 130 is substantially as described above in the previous embodiments, and the attachable filter 130 exhibits a first color.

The plasma display panel 100 includes a front substrate 110′, a rear substrate 120, and barrier ribs 124 defining a plurality of discharge cells S between the front substrate 110′ and the rear substrate 120. The front substrate 110′ is colored with a second color. Phosphors 125 are coated in areas defined by the barrier ribs 124. The phosphors 125 are colored with the first color. The first color of the front substrate 110′ and the second color of the phosphors 125 may be selected from complementary color pairs. For example, the first color and the second color may be selected from complementary blue and orange colors.

Here, mixing the first color of the attachable filter 130 and the second color of the front substrate 110′ produces a black color, by a complementary color effect. Further, mixing the second color of the front substrate 110′ and the first color of the phosphors 125 provides another complementary color effect. Thus, when the plasma display device is viewed from outside, the first color of the attachable filter 130, the second color of the front substrate 110′, and the first color of the phosphors 125 combine to thereby achieve a double-complementary color effect. The double-complementary color effect produces a darker black color with lower brightness and saturation, thereby increasing an external light absorption effect. Effectiveness of the double-complementary color effect can be demonstrated by comparing a double-complementary color structure according to the fifth embodiment of the present invention with a single-complementary color structure as illustrated in FIG. 2 in terms of external light reflection brightness and a bright room contrast ratio. The external light reflection brightness of a double-complementary color structure according to the fifth embodiment of the present invention is about 8.2 cd/m² which is improved as compared with the external light reflection brightness (about 10.2 cd/m²) of a single-complementary color structure. Moreover, as measured under the same conditions, the bright room contrast ratio of a single-complementary color structure is about 93:1, and the bright room contrast ratio of a double-complementary color structure according to the fifth embodiment of the present invention is about 120:1. This shows that a bright room contrast may be significantly improved using a number of combinations of complementary colors.

In the plasma display device according to the fifth embodiment of the present invention, the complementary first and second colors are alternately repeated to achieve a double-complementary color effect. However, the attachable filter 130, the front substrate 110′, and the phosphors 125 may also be colored with different colors. Here, a first color of the attachable filter 130, a second color of the front substrate 110′, and a third color of the phosphors 125 undergo a subtractive color mixing when overlapped, thereby producing a dark color.

### Sixth Embodiment

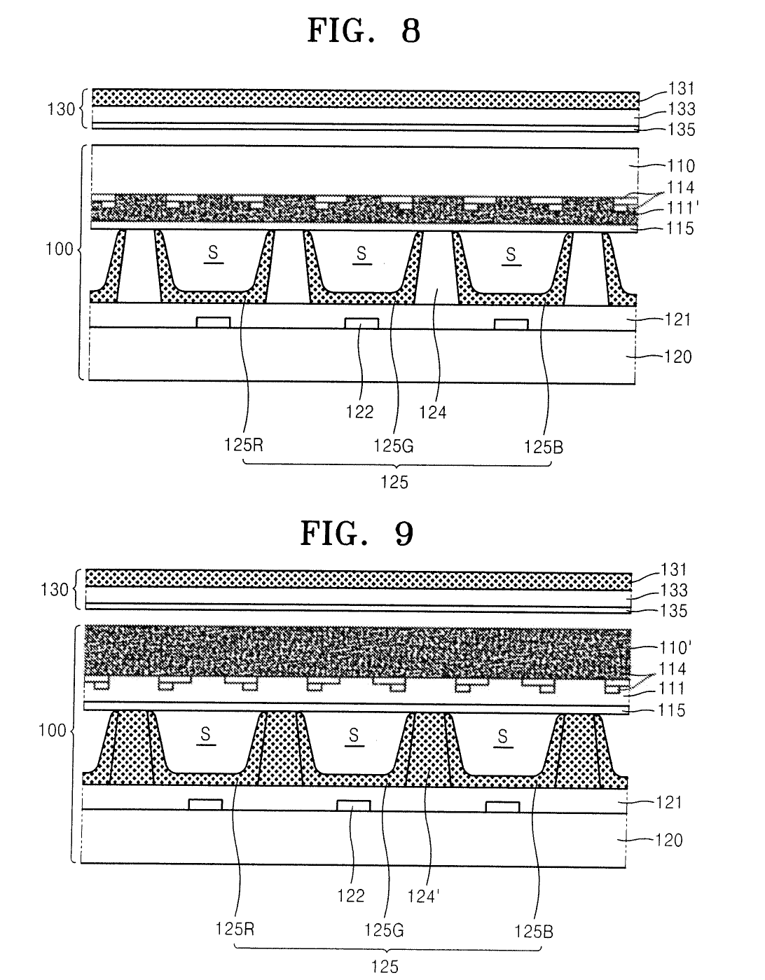

FIG. 8 is a cross-sectional view illustrating a plasma display device according to a sixth embodiment of the present invention. In the sixth embodiment of the present invention, as described above, complementary first and second colors are alternately repeated to thereby achieve a double-complementary color effect. In more detail, an attachable filter 130 is colored with a first color, a front dielectric layer 111′ is colored with a second color, and phosphors 125 are colored with the first color. Thus, when the attachable filter 130, the front dielectric layer 111′, and the phosphors 125 overlapping, a color combination of the attachable filter 130 and the front dielectric layer 111′ provides a subtractive color mixing effect, and a color combination of the front dielectric layer 111′ and the phosphors 125 provides another subtractive color mixing effect. The sixth embodiment of the present invention provides a double-complementary color effect, like the previous fifth embodiment, but is different from the previous fifth embodiment in that the front dielectric layer 111′ is colored instead of a front substrate 110. That is, constitutional elements to be colored can be selected in view of convenience of coloration process.

### Seventh Embodiment

FIG. 9 is a cross-sectional view illustrating a plasma display device according to a seventh embodiment of the present invention. In the seventh embodiment of the present invention, in order to achieve a double-complementary color effect, an attachable filter 130, a front substrate 110′, and phosphors 125, which are sequentially disposed from top to bottom, are alternately colored with complementary first and second colors. The seventh embodiment of the present invention is different from the previous fifth embodiment in that barrier ribs 124′ defining areas for coating the phosphors 125 are colored with the same color as the phosphors 125. Generally, a barrier rib material appears white, and thus, reflects external light, thereby lowering image quality. According to the fifth embodiment of the present invention, the white color of barrier ribs is not exposed to the outside due to coloration of an attachable filter and a front substrate, and thus, a reduction in contrast due to reflection of external light from the barrier ribs may be relatively small as compared with a conventional structure. However, according to the seventh embodiment of the present invention, when the barrier ribs 124′ corresponding to non-display areas are colored with the same color as the phosphors 125, areas capable of achieving a double-complementary color effect with the attachable filter 130 and the front substrate 110′ are substantially extended over an entire image display surface.

### Eighth Embodiment

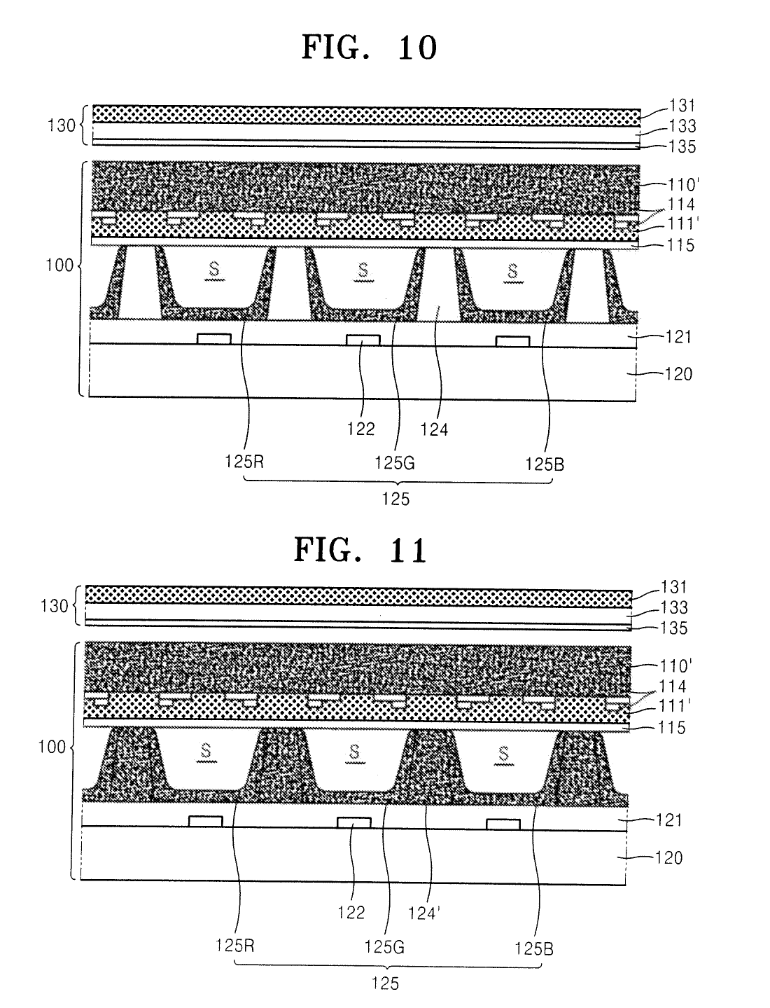

FIG. 10 is a cross-sectional view illustrating a plasma display device according to an eighth embodiment of the present invention. In the eighth embodiment of the present invention, complementary first and second colors are alternately stacked to achieve a multiple-complementary color effect. Referring to FIG. 10, an attachable filter 130, a front substrate 110′, a front dielectric layer 111′, and phosphors 125 are respectively colored with the first color, the second color, the first color, and the second color. Thus, a combination of the first color of the attachable filter 130 and the second color of the front substrate 110′ provides a complementary color effect, a combination of the second color of the front substrate 110′ and the first color of the front dielectric layer 111′ provides another complementary color effect, and a combination of the first color of the front dielectric layer 111′ and the second color of the phosphors 125 provides a further complementary color effect. Thus, the plasma display device according to the eighth embodiment of the present invention appears darker black through a triple-complementary color effect, thereby providing clearer images without a reduction in image quality due to external light.

Effectiveness of the triple-complementary color effect can be demonstrated by comparing external light reflection brightness and a bright room contrast ratio. External light reflection brightness gradually decreases from a single-complementary color structure (about 10.2 cd/m²), to a double-complementary color structure (about 8.2 cd/m²), and to a triple-complementary color structure (about 6.6 cd/m²). Moreover, as measured under the same conditions, the bright room contrast ratio of a single-complementary color structure is about 93:1, the bright room contrast ratio of a double-complementary color structure is about 120:1, and the bright room contrast ratio of a triple-complementary color structure according to the eighth embodiment of the present invention is about 151:1. This shows that a multiple-complementary color effect can significantly improve a bright room contrast ratio. When comparing a conventional structure having no complementary color effect with a structure according to the eighth embodiment of the present invention, the external light reflection brightness of the structure of the eighth embodiment of the present invention is about 6.6 cd/M², which is significantly improved as compared with the external light reflection brightness (about 15.2 cd/m²) of the conventional structure. Thus, the bright room contrast ratio of the structure of the eighth embodiment of the present invention is about 151:1, which is significantly improved as compared with the bright room contrast ratio (about 70:1) of the conventional structure.

The first color and the second color can be optionally selected from many complementary color pairs in consideration of process convenience, individual preference, or the like. For example, a blue-orange color pair may be used. Further, the attachable filter 130 directly exposed to external light may be colored with a color having a low brightness, thereby increasing the absorption of external light. In this regard, when the first color and the second color are mutually exclusively selected from a blue color and an orange color, the attachable filter 130 directly exposed to external light may be colored with the blue color having a lower brightness.

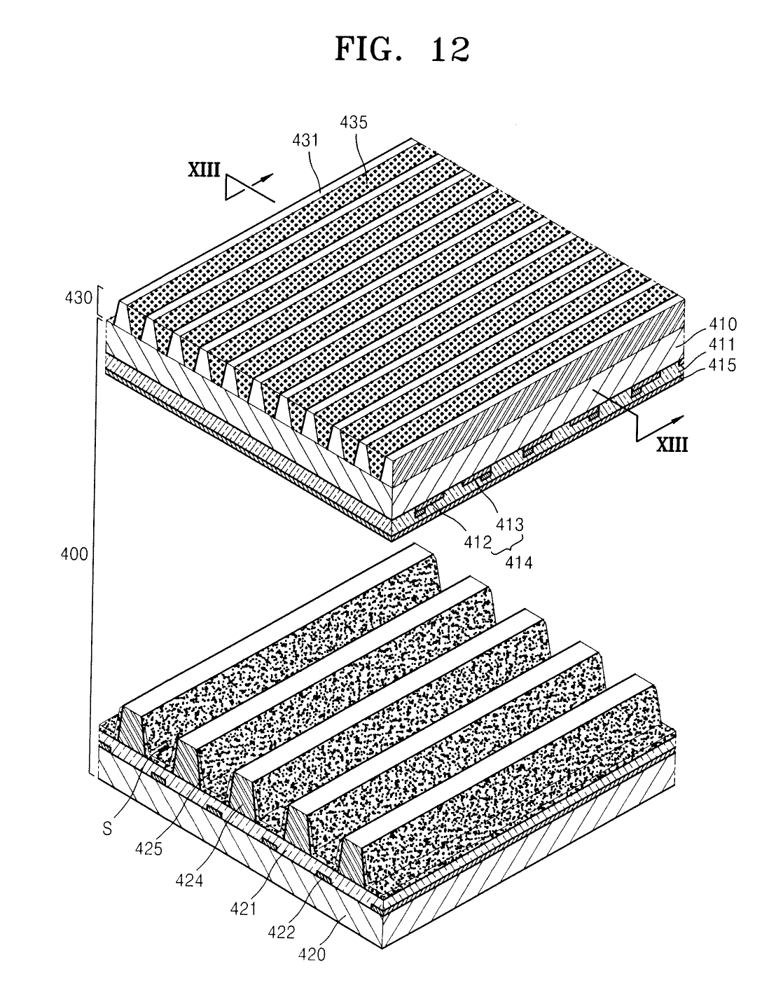

Referring to FIG. 11 illustrating a modified embodiment of the embodiment of FIG. 10, barrier ribs 124′ defining areas intended for coating phosphors 125 may be colored with the same color as the phosphors 125. In this case, the barrier ribs 124′ and the phosphors 125, together with an attachable filter 130, a front substrate 110′, and a front dielectric layer 111′ disposed above the barrier ribs 124′ and the phosphors 125, can achieve a multiple combination of a first color and a second color over a wider area.

### Ninth Embodiment

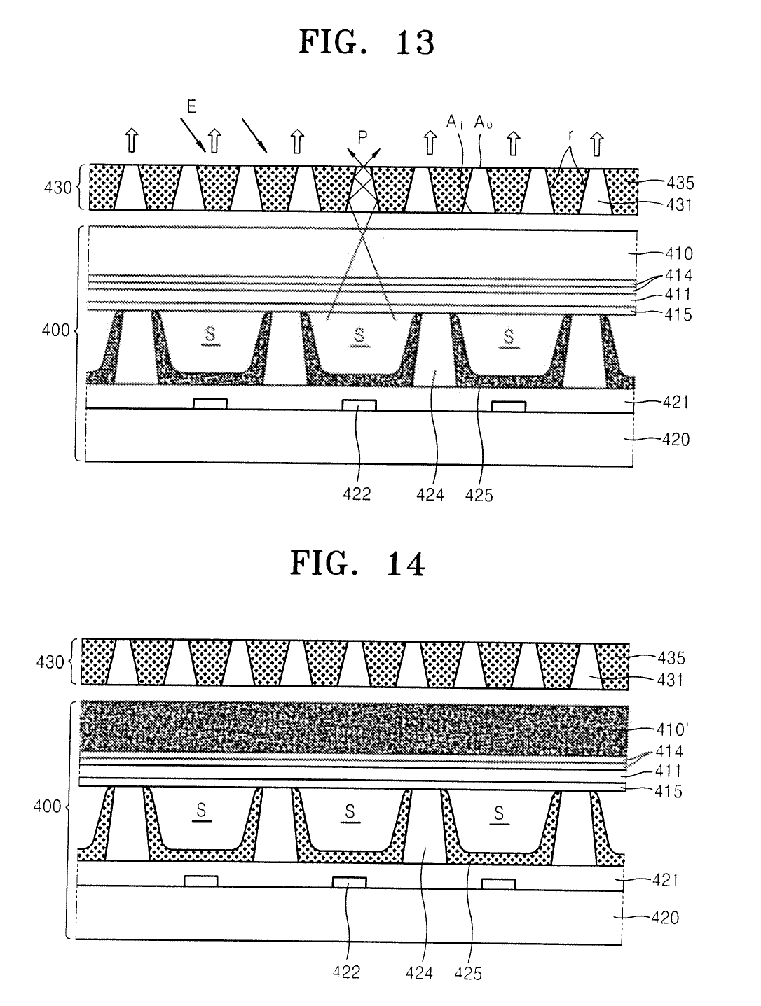

FIG. 12 is an exploded perspective view illustrating a plasma display device according to a ninth embodiment of the present invention, and FIG. 13 is a cross-sectional view taken along a line XIII-XIII of FIG. 12. Referring to FIGS. 12 and 13, the plasma display device includes a plasma display panel 400 and a front filter 430 attached to an image display surface of the plasma display panel 400. The front filter 430 includes a transparent substrate 431 and external light-absorbing patterns 435 which are arranged at distances (e.g. predetermined distances) in the transparent substrate 431 and have a width of several tens of micrometers. The external light-absorbing patterns 435 may have an inverted trapezoidal profile. In addition, the external light-absorbing patterns 435 may have various profile shapes, e.g., an inverted triangle. The external light-absorbing patterns 435 may be colored with a first color. The colored external light-absorbing patterns 435 may be formed by adding a first coloring material to the transparent substrate 431 at intervals (e.g. regular intervals). Here, the transparent substrate 431 may be made of polycarbonate or the like, and the external light-absorbing patterns 435 may include a blue-coloring material such as Mn, Ni, or Co. Reflective surfaces r may be formed on sidewalls of the external light-absorbing patterns 435. The reflective surfaces r may be formed as metal coating layers made of a metal with high reflectivity, e.g., aluminum. Display light P generated by a sustain discharge in the plasma display panel 400 is reflected from the reflective surfaces r and guided toward outside while passing between the external light-absorbing patterns 435, thereby creating images that can be sensed by a viewer. The external light-absorbing patterns 435 define therebetween incidence planes Ai and output planes Ao. The output planes Ao may be formed to be narrower than the incidence planes Ai. Here, the display light P passing through the front filter 430 is focused along the optical axes in transmission areas gradually decreasing from the incidence planes Ai to the output planes Ao. The focused light has greater brightness and vividness, thereby enhancing image sharpness, and resulting in high definition and high precision images such as XGA or SXGA. The front filter 430 may be directly attached to the image display surface of the plasma display panel 400 via an adhesive layer, or alternatively, may be disposed to be spaced apart from the plasma display panel 400 using a separate fixing member.

The plasma display panel 400 includes a front substrate 410 and a rear substrate 420 that are disposed to face each other and are separated from each other by a distance (e.g. a predetermined distance), and barrier ribs 424 interposed between the front substrate 410 and the rear substrate 420. A plurality of discharge electrode pairs 414 extending parallel to each other are arranged on the front substrate 410, and each of the paired discharge electrodes 412 and 413 may include a transparent electrode and a bus electrode that are disposed to face each other in a vertical direction. The discharge electrode pairs 414 are buried in (or covered by) a dielectric layer 411. The dielectric layer 411 is covered with a protective layer 415. A plurality of address electrodes 422 are arranged on the rear substrate 420 and extend to cross the discharge electrode pairs 414. The address electrodes 422 are buried in (or covered by) a dielectric layer 421. The barrier ribs 424 are disposed on the dielectric layer 421 to define a plurality of discharge cells S. Phosphors 425 are coated in areas defined by the barrier ribs 424.

In the ninth embodiment of the present invention, the phosphors 425 are colored with a second color complementary to the first color of the front filter 430. For example, the complementary first and second colors may be selected from blue-orange combinations. The phosphors 425 may include an orange-coloring material such as Cu, Sb, or Cr. As described above, subtractive color mixing of the complementary first and second colors occurs in overlapping regions of the front filter 430 (more specifically, the external light-absorbing patterns 435 of the front filter 430) and the phosphors 425, thereby producing a black color or a near-black color which is advantageous for absorption of external incident light E.

As measured under the same conditions, the external light reflection brightness of a plasma display device according to the ninth embodiment of the present invention is about 8.0 cd/M², which is significantly reduced as compared with the external light reflection brightness (about 15.2 cd/M²) of a conventional colorless plasma display device having the same structure as the plasma display device according to the ninth embodiment of the present invention. The external light reflection brightness affects a bright room contrast ratio, which is an indicator of image quality. Thus, the bright room contrast ratio of the conventional plasma display device is about 70:1, whereas the bright room contrast ratio of the plasma display device according to the ninth embodiment of the present invention is about 125:1, showing a significant improvement in image quality.

Black external light-absorbing patterns 435 can reduce external light reflection brightness to some degree without using a combination of complementary colors, unlike in the ninth embodiment of the present invention. In this case, however, reflection of external light occurring in areas defined between the external light-absorbing patterns 435 may not be prevented (or reduced). Moreover, since a coloring material (e.g., a blue pigment) having a higher brightness than a black pigment can lower manufacturing costs, the absorption of external light based on a complementary color principle, rather than the absorption of external light based on simple blackening of external light-absorbing patterns, may reduce manufacturing costs.

### Tenth Embodiment

FIG. 14 is a cross-sectional view illustrating a plasma display device according to a tenth embodiment of the present invention. Referring to FIG. 14, a front substrate 410′ facing a front filter 430 is colored with a second color. The second color is a color complementary to a first color of external light-absorbing patterns 435. For example, the first color and the second color may be selected from blue-orange combinations. Overlapping regions of the external light-absorbing patterns 435 and the front substrate 410′ exhibit black or near-black through subtractive color mixing of the first color and the second color. This shows that the subtractive color mixing of complementary colors can reduce the reflection of external light through absorption of the external light, thereby enhancing contrast.

Barrier ribs 424 defining discharge cells S are disposed between the front substrate 410′ and a rear substrate 420, and phosphors 425 colored with the first color are coated in the discharge cells S for a double-complementary color effect. That is, subtractive color mixing occurs between the external light-absorbing patterns 435 and the front substrate 410′ that are colored with the complementary colors, and another subtractive color mixing occurs between the front substrate 410′ and the phosphors 425 that are colored with the complementary colors. Such a double-complementary color effect makes regions (e.g., predetermined regions) of a plasma display panel 400 appear darker black, which is more advantageous for absorption of external light.

A front dielectric layer 411 may also be colored instead of the front substrate 410′. In this case, as described above, subtractive color mixing between the external light-absorbing patterns 435 and the front dielectric layer 411 that are colored with complementary colors produces a black-based color capable of absorbing external incident light. Of course, both the front substrate 410′ and the front dielectric layer 411 may also be colored.

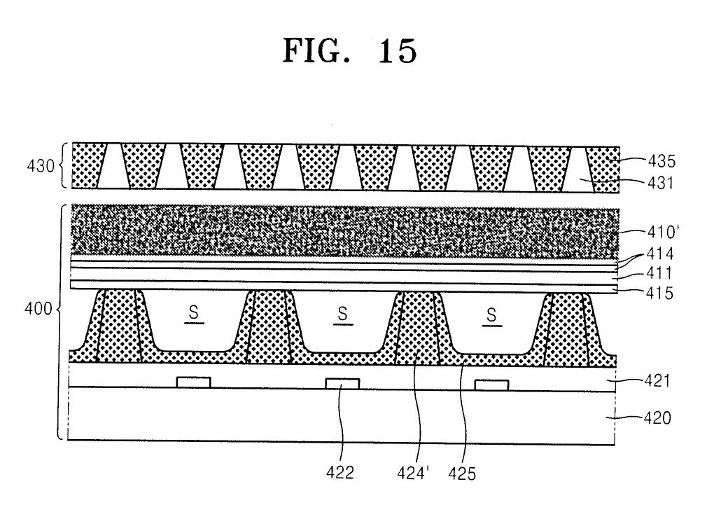

FIG. 15 is a cross-sectional view illustrating a plasma display device according to a modified embodiment of the embodiment of FIG. 14. The current embodiment of the present invention is different from the previous tenth embodiment in that barrier ribs 424′ are colored with the same color as phosphors 425 on a surface of a rear substrate 420. By doing so, areas exhibiting a complementary color effect with a front substrate 410′ can extend to non-display areas corresponding to the barrier ribs 424′, thereby facilitating the absorption of external light over a wider area.

In the present invention, an attachable filter and elements (e.g., predetermined elements) of a plasma display panel are colored with complementary colors, thereby making an image display surface appear black through subtractive color mixing. Therefore, it may not be necessary to form common black stripes used for absorbing external light, thereby reducing manufacturing costs and the number of manufacturing processes, resulting in an increase in production yield. Moreover, unlike a conventional plasma display device in which absorption of external light occurs only in non-display areas corresponding to black stripes, in the present invention, the absorption of external light can be substantially achieved over an entire image display surface, including both display and non-display areas.

In particular, according to the present invention, for external light absorption, a display can be designed to have a combination of complementary colors repeatedly stacked between an attachable filter and elements of a plasma display panel when needed, thereby significantly enhancing image vividness according to a required specification.

In addition, a colored attachable filter according the present invention can solve disadvantages of a conventional glass filter while maintaining an intrinsic filter function. Therefore, the attachable filter according to the present invention may be integrally attached to a front surface of a display panel without using a separate fixing member, thereby increasing the convenience of manufacturing processes.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display device comprising:
a plasma display panel adapted to create images and comprising a front substrate, a rear substrate, a plurality of discharge cells defined between the front substrate and the rear substrate, and phosphors coated in the discharge cells; and
a filter attached to a front surface of the front substrate and adapted to serve as an image display surface,
wherein the filter and the phosphors are respectively colored with first and second colors that are different from each other.

2. The plasma display device of claim 1, wherein the first color and the second color are complementary colors.

3. The plasma display device of claim 1, wherein the first color and the second color are mutually exclusively selected from a blue color and an orange color.

4. The plasma display device of claim 1, wherein the phosphors comprise red phosphors, green phosphors, and blue phosphors, wherein the red phosphors and the blue phosphors are colored with the second color and the green phosphors are not colored.

5. The plasma display device of claim 1, wherein the filter comprises a base film and an electromagnetic wave-shielding layer facing each other, and the base film is colored with the first color.

6. The plasma display device of claim 1, wherein the filter is a single-layered filter comprised of a composite material comprising a base film material and an electromagnetic wave-shielding material.

7. The plasma display device of claim 1, wherein the filter comprises:
a base film;
an anti-glare/anti-reflective layer supported at the front of the base film;
an electromagnetic wave-shielding layer supported at the back of the base film to shield electromagnetic waves; and
an adhesive layer for binding the base film and the plasma display panel, and
wherein at least one of the base film, the anti-glare/anti-reflective layer, or the adhesive layer is colored with the first color.

8. The plasma display device of claim 1, wherein the filter comprises:
a first base film;
an anti-glare/anti-reflective layer supported at the front of the first base film;
a second base film disposed at the back of the first base film;
an electromagnetic wave-shielding layer disposed at the back of the second base film; and
an adhesive layer for binding the electromagnetic wave-shielding layer and the plasma display panel,
wherein at least one of the first base film, the anti-glare/anti-reflective layer, the second base film, or the adhesive layer is colored with the first color.

9. The plasma display device of claim 1, wherein barrier ribs defining the plurality of the discharge cells are between the front substrate and the rear substrate, and
wherein the barrier ribs are colored with the same color as the phosphors.

10. A plasma display device comprising:
a plasma display panel for creating images and comprising a front substrate, a rear substrate, a plurality of discharge cells defined between the front substrate and the rear substrate, and phosphors coated in the discharge cells; and
a filter attached to a front surface of the front substrate and adapted to serve as an image display surface,
wherein complementary first and second colors alternate from front to back so that the filter is colored with the first color, the front substrate is colored with the second color, and the phosphors are colored with the first color.

11. The plasma display device of claim 10, wherein the first color and the second color are mutually exclusively selected from a blue color and an orange color.

12. The plasma display device of claim 10, wherein barrier ribs defining the plurality of the discharge cells are between the front substrate and the rear substrate, and
wherein the barrier ribs are colored with the same color as the phosphors.

13. A plasma display device comprising:
a plasma display panel comprising a front substrate supporting a plurality of discharge electrodes, a front dielectric layer covering the discharge electrodes, barrier ribs defining a plurality of discharge cells between the front substrate and the rear substrate, phosphors coated in the discharge cells, and a discharge gas filled in the discharge cells; and
a filter attached to a front surface of the front substrate and adapted to serve as an image display surface,
wherein complementary first and second colors alternate from front to back so that the filter is colored with the first color, the front substrate is colored with the second color, the front dielectric layer is colored with the first color, and the phosphors are colored with the second color.

14. The plasma display device of claim 13, wherein the barrier ribs are colored with the same color as the phosphors.

15. A plasma display device comprising:
a plasma display panel adapted to create images and comprising a front substrate, a rear substrate, a plurality of discharge cells disposed between the front substrate and the rear substrate, and phosphors coated in the discharge cells; and
a front filter at a front of the front substrate and adapted to serve as an image display surface, comprising a transparent substrate and a plurality of external light-absorbing patterns arranged at intervals in the transparent substrate,
wherein the external light-absorbing patterns and the phosphors are respectively colored with complementary first and second colors.

16. The plasma display device of claim 15, wherein the first color and the second color are mutually exclusively selected from a blue color and an orange color.

17. The plasma display device of claim 15, wherein barrier ribs defining the plurality of the discharge cells are between the front substrate and the rear substrate, and
wherein the barrier ribs are colored with the same color as the phosphors.

18. The plasma display device of claim 15, wherein the external light-absorbing patterns have an inverted trapezoidal profile.

19. The plasma display device of claim 15, wherein reflective surfaces are formed at sides of the external light-absorbing patterns.

20. A plasma display device comprising:
a plasma display panel adapted to create images and comprising a front substrate, a rear substrate, a plurality of discharge cells disposed between the front substrate and the rear substrate, and phosphors coated in the discharge cells; and
a front filter, at a front of the front substrate and adapted to serve as an image display surface, comprising a transparent substrate and a plurality of external light-absorbing patterns arranged at intervals in the transparent substrate,
wherein complementary first and second colors alternate from front to back so that the external light-absorbing patterns are colored with the first color, the front substrate is colored with the second color, and the phosphors are colored with the first color.

21. The plasma display device of claim 20, wherein barrier ribs defining the plurality of the discharge cells are between the front substrate and the rear substrate, and
wherein the barrier ribs are colored with the same color as the phosphors.
